(19) United States
(12) Patent Application Publication
(10) Pub. No.: US 2004/0194415 A1
(43) Pub. Date: Oct. 7, 2004

(54) Insulating sheet plug

(76) Inventors: Albert Frischmann, Kenzingen (DE); Johannes Rieger, Herbolzheim (DE)

Correspondence Address: Striker S triker & Stenby, 103 East Neck Road, Huntington, NY, 11743, US

(21) Appl. No.: 10/486,553

(22) PCT Filed: Jun. 20, 2002
(86) PCT No.: PCT/EP02/06823

(30) Foreign Application Priority Data
Aug. 16, 2001 (DE) 101 40 278.3

(51) Int. Cl. E04B 1/38

(52) U.S. Cl. 52/698

(57) ABSTRACT

The invention relates to an insulating panel fixing plug (10) having a hollow shank (12) with a holding plate (14) and having a clamping sleeve (18) protruding from the hollow shank (12). The invention provides for a closure part (24) to be arranged in the hollow shank (12), which closure part, as the insulating panel fixing plug (10) is set in position, is separated at a rupturable junction into two parts (30, 32), of which one part (30) is pulled back against a rear end of the hollow shank (12) as a drill bit (26) is withdrawn from the insulating panel fixing plug (10), and thereby closes off a cavity (16) of the hollow shank (12).

The invention relates to an insulating panel fixing plug having the features of the preamble to claim 1.

Such insulating panel fixing plugs are known per se. They have a hollow shank with a holding plate at one end, the holding plate having a through-hole through which a cavity of the hollow shank is accessible for introduction of a driving-in tool. Normally, the hollow shank and the holding plate consist of plastics material and are in one piece with one another, although neither of these is obligatory. The insulating panel fixing plugs serve for fixing insulating panels to a wall. They are inserted through the insulating panels into a hole drilled in the wall and with their holding plates hold the insulating panels against the wall.

It is a disadvantage that the cavity in the hollow shank of the insulating panel fixing plug forms a cold bridge. Furthermore, in the case of insulating panel fixing plugs that have corrodible steel parts there is a danger that rust particles will get through the cavity of the hollow shank into a plaster layer that is applied to the insulating panels, after the insulating panel fixing plugs have been set in place, and covers their holding plates. The rust particles cause unsightly patches on the plaster layer. It has therefore been proposed on several occasions to close off the cavity of the hollow shank with a cover or a stopper after the insulating panel fixing plug has been set in position. This has the drawback, however, that an additional work step is required, and there is no guarantee that the cavities of the positioned insulating panel fixing plugs will actually and in all cases be closed off prior to applying the plaster layer.

The invention is based on the problem of proposing an insulating panel fixing plug that can be set in position with minimum effort and which avoids the formation of a cold bridge through the cavity of its hollow shank.

That problem is solved in accordance with the invention by the features of claim 1. In the hollow shank of the insulating panel fixing plug according to the invention a closure part is arranged, which closes off the hollow shank and which transfers driving-in energy for driving the insulating panel fixing plug into a drilled hole from a driving-in tool introduced into the cavity of the hollow shank of the insulating panel fixing plug to the insulating panel fixing plug. Closure of the cavity of the hollow shank by the closure part need not be absolutely hermetically tight, even if this is preferred. A non-hermetically tight closure part, which allows, for example, air to enter and exit from the cavity of the hollow shank past the closure part and/or through the same, also avoids the formation of a cold bridge through the cavity of the hollow shank.

Provision is made for the insulating panel fixing plug according to the invention to be driven into a pre-drilled hole by impact from a percussion drill or a rotary hammer. For that purpose, the insulating panel fixing plug is placed with its hollow shank on a drill bit clamped in the percussion drill or the rotary hammer, the drill bit constituting the driving-in tool. Impact energy or driving-in energy exerted by a drill bit during driving in is transferred from the closure part to a larger area in the hollow shank of the insulating panel fixing plug. Damage to the insulating panel fixing plug by the impact action of the drill bit is consequently avoided.

For anchoring in a hole drilled in a wall, the insulating panel fixing plug can comprise, for example, a fixing plug expandable by insertion of an expander body, for example, an expander nail or screw nail, or a nail inserted in the hollow shank is hammered directly into, for example, a timber substrate. One construction of the invention provides a clamping sleeve, which protrudes from the hollow shank at the end remote from the holding plate. The insulating panel fixing plug, together with the clamping sleeve, is driven into a hole drilled in a wall. When set in position, the hollow shank of the insulating panel fixing plug is located in an insulating panel applied to the wall.

In order more easily to locate the drilled hole in the wall with the clamping sleeve through a mounted insulating panel, even when the insulating panel has perhaps shifted on the wall somewhat after the hole has been drilled, a construction of the invention provides for the clamping sleeve to have a centring tip.

A construction of the invention provides a location seat for the driving-in tool at the closure part arranged in the cavity of the hollow shank. The location seat can be, for example, a conical recess for centring a drill bit used as driving-in tool. Preferably, the location seat is in the form of a blind bore, the base of which, for example, can be flat or conical. The location seat receives the drill bit used as driving-in tool in the region of its tip or alternatively over a larger part of its length. The closure part can be axially short and extend axially only over a short part of the cavity of the hollow shank. Alternatively, the closure part can extend axially over a relatively large part of the length of the cavity of the hollow shank, also over virtually all of or the entire length of the cavity. An axially longer closure part renders possible a longer location seat for the driving-in tool and hence lateral support of the driving-in tool. The danger that the driving-in tool will break is therefore reduced, and a thin and long drill bit can be used as driving-in tool. The fact that, after the insulating panel fixing plug has been set in position, the location seat remains as a long cavity is in many cases not significant, since the cavity is concealed by a plaster layer.

One construction of the invention provides for the location seat of the closure part to engage the driving-in tool with a wedged fit, and for the insulating panel fixing plug to have a retaining device, which retains the closure part in the hollow shank of the insulating panel fixing plug as the driving-in tool is withdrawn. A drill bit used as driving-in tool can, for example, press itself into or cut into a wall of the location seat in the closure part. The retaining device can comprise, for example, projections and/or recesses on the circumference of the closure part and complementary recesses and/or projections in the cavity of the hollow shank. Alternatively, for example, an inwardly projecting bead or collar, which prevents the closure part from being pulled out, can be provided in the hollow shank. The retaining device is preferably arranged so that the closure part can be drawn back as far as the region of the end of the hollow shank having the holding plate. As the driving-in tool is withdrawn, the closure part is therefore pulled as far as the end of the hollow shank having the holding plate and closes off the cavity there. In this way, a cold bridge is effectively prevented; the cavity of the hollow shank contains an insulating air cushion. Furthermore, the closure part closing off the cavity of the hollow shank in the region of the holding plate prevents ingress of plaster into the cavity.

One construction of the invention provides for a rupturable junction on the closure part, at which the closure part is separated into an axially front and an axially rear part by the driving-in energy applied as the insulating panel fixing plug is driven into a drilled hole. This construction of the invention has the advantage of decoupling rotation between the front and the rear parts of the closure part, so that the rear part is able to co-rotate with a drill bit used as driving-in tool. A further advantage of this construction of the invention is that, after the insulating panel fixing plug has been set in position, as the drill bit is pulled out of the insulating panel fixing plug, the rear part of the closure part can be pulled back with the drill bit into the region of the end of the hollow shank having the holding plate. The two parts of the closure part therefore close off the cavity of the hollow shank at both ends of the cavity and trap an air cushion between them in the cavity. A cold bridge is therefore avoided and a good insulating effect is achieved.

The invention is explained in detail in the following with reference to the exemplary embodiments illustrated in the drawings, in which:

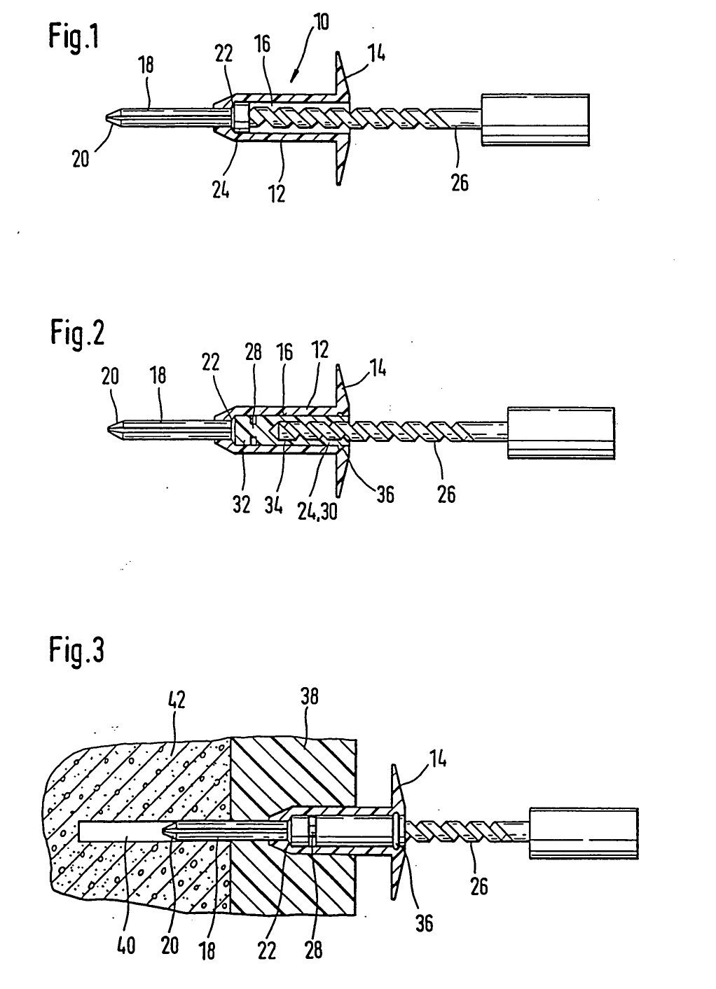

FIG. 1 is an axial section of a first embodiment of an insulating panel fixing plug according to the invention;

FIG. 2 is an axial section of a second embodiment of an insulating panel fixing plug according to the invention;

FIG. 3 shows the insulating panel fixing plug from FIG. 2 as it is being set in position;

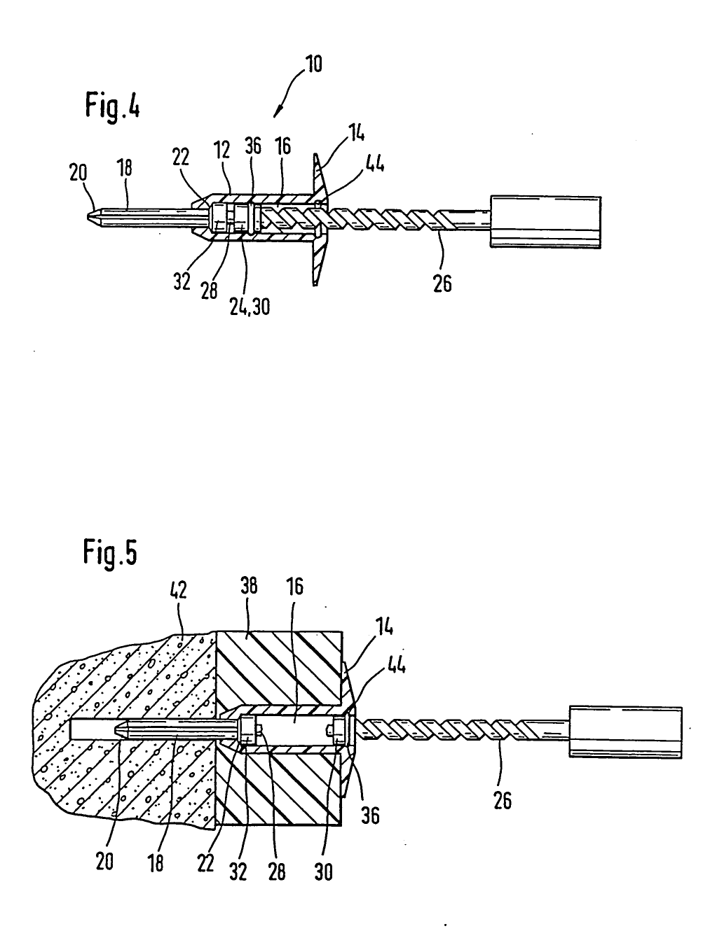

FIG. 4 is an axial section of a third embodiment of an insulating panel fixing plug according to the invention; and

FIG. 5 shows the insulating panel fixing plug from FIG. 4 at the end of the positioning operation.

The insulating panel fixing plug 10 according to the invention illustrated in FIG. 1 comprises a substantially cylindrical hollow shank 12 with a circular ring disc-shaped holding plate 14 at one end. A cavity 16 in the hollow shank 12 of the insulating panel fixing plug 10 is accessible through a central hole of the circular ring disc-shaped holding plate 14. The hollow shank 12 and the holding plate 14 are manufactured in one piece from plastics material.

At the end remote from the holding plate 14, the hollow shank 12 has a clamping sleeve 18, which protrudes from the hollow shank 14, lengthening this coaxially. At its end protruding from the hollow shank 12, the clamping sleeve 18 has a centring tip 20. At the end received in the hollow shank 12, the clamping sleeve 18 is provided with a circumferential, laterally outwardly projecting flange 22.

A cylindrical closure part 24 of plastics material is arranged at the bottom of the cavity 16 of the hollow shank 12. The closure part 24 sits on the flange 22 of the clamping sleeve 18, lies wedged in the hollow shank 12 and closes this off. At its end face remote from the clamping sleeve 18, the closure part 24 can have a conical recess as location seat for centring a drill bit.

The insulating panel fixing plug 10 is provided for fixing insulating panels to a wall. To position the insulating panel fixing plug 10, with a drill bit that is clamped in a percussion drill or a rotary hammer a hole is drilled right through an insulating panel offered up to the wall, and into the wall (not shown). The insulating panel fixing plug 10 is then placed with its hollow shank 12 on the drill bit 26 and, by impact from the percussion mechanism of the percussion drill, not shown, or the rotary hammer, not shown, the insulating panel fixing plug 10 is driven with its clamping sleeve 18 right through the insulating panel into the hole drilled in the masonry. The drill bit 26 is used as driving-in tool for setting the insulating panel fixing plug 10 in position. After the drill hole has been drilled, the drill bit 26 does not need to be released from the chuck. The clamping sleeve 18 anchors the insulating panel fixing plug 10 in the wall. When the insulating panel fixing plug 10 is set in position, the hollow shank 12 is located in the insulating panel, the holding plate 4 sits on an outer side of the insulating panel remote from the wall and holds the insulating panel against the wall.

The closure part 24 transfers the impact and driving-in energy from the drill bit 26 to the insulating panel fixing plug 10 and especially to the clamping sleeve 18 thereof. The closure part 24 prevents damage to the insulating panel fixing plug 10 by the drill bit. After the insulating panel fixing plug 12 has been set in position, the drill bit 26 is withdrawn from the hollow shank 12 and the next drilled hole can be drilled and the next insulating panel fixing plug can be set in position. The closure part 24 remains in the hollow shank 12, forming an insulation, and prevents a cold bridge through the cavity 16 of the hollow shank 12. In addition, the closure part 24 prevents water and atmospheric moisture from reaching the clamping sleeve 18, and prevents rust particles from the clamping sleeve 18, if this does not consist of a corrosion-resistant material, from passing in the reverse direction into the cavity 16 and through this to a plaster layer covering the insulating panel fixing plug 10, and from being able to cause unsightly patches there. By virtue of the closure part 24, there is no need to switch off the rotary drive of the drill bit 26 as the insulating panel fixing plug 10 is being set in position.

After the insulating panel fixing plug 10 has been set in position and the drill bit 26 has been withdrawn, the cavity 16 can be closed off with a cover or a stopper, in order to prevent ingress of plaster (not illustrated) into the cavity 16. Such a cover or stopper need not seal the cavity 16 hermetically tightly, provision can be made for admission of air to and exit of air from the cavity 16 past the cover or stopper or through the same.

Consistent with the insulating panel fixing plug 10 from FIG. 1, the insulating panel fixing plug 10 represented in FIG. 2 comprises a hollow shank 12 with a holding plate 14 and a clamping sleeve 18 with centring tip 20 and a flange 22 at the end of the clamping sleeve 18 received in the hollow shank 12. Only the closure part 24 is of different construction in the insulating panel fixing plug 10 represented in FIG. 2. The closure part 24 extends over the entire axial length of the cavity of the hollow shank 12. The closure part 24 has a rupturable junction 28, which is formed by a circumferential and deep constriction. The rupturable junction 28 is located close to the flange 22 of the clamping sleeve 18 and divides the closure part 24 into an axially long, rear part 30 and an axially short, front part 32. The two parts 30, 32 of the closure part 24 are initially joined in one piece with one another by way of the rupturable junction 28.

The rear part 30 of the closure part 24 has a cylindrical blind bore, which forms a location seat 34 for a drill bit 26. An inserted drill bit 26 is held wedged in the location seat 34 of the rear part 30 of the closure part 24.

Axially at the level of the holding plate 14, the closure part 24 has a circumferential bead 36, which lies in a complementary circumferential groove in the cavity 16 of the hollow shank 12. The bead 36 and the groove in which it is located form a retaining device, which holds the closure part 24 in the hollow shank 12 as the drill bit 26 is withdrawn.

Setting the insulating panel fixing plug 10 in position is effected, with necessary changes, in the same way as described with reference to FIG. 1. With the blind bore of the closure part 24 forming the location seat 34 for the drill bit 26, the insulating panel fixing plug 10 is placed on the drill bit 26 and, by rotary and percussive action applied to it, is driven right through an insulating panel 38 into a hole 40 drilled in a wall 42 (FIG. 3). The rotary and percussive action causes the closure part 24 to shear at the rupturable junction 28, so that the closure part 24 is separated into the axially rear part 30 and the axially front part 32. The two parts 30, 32 are decoupled in respect of rotation, the rear part 30 rotates together with the drill bit 26, whereas the front part 32 does not rotate therewith. After the insulating panel fixing plug 10 has been set in position, the drill bit 26 is withdrawn, the retaining device 36 holds the rear part 30 of the closure part 24 in the cavity 16 of the hollow shank 12.

In the case of the insulating panel fixing plug 10 represented in FIG. 4, the axially rear part 30 of the closure part 24 is axially considerably shorter than in FIG. 2; the axially rear part 30 of the closure part 24 occupies in FIG. 4 only part of the axial length of the cavity 16 of the hollow shank 12. For the rest, the insulating panel fixing plug 10 of FIG. 4 is of the same construction as that of FIG. 2, in particular, the closure part 24 has a rupturable junction 28 formed by a circumferential and deep constriction. Setting of the insulating panel fixing plug 10 of FIG. 4 in position is also effected in the same way as described above with reference to FIGS. 2 and 3. Nevertheless, after setting the insulating panel fixing plug 10 in position, on withdrawing the drill bit 26, because the rear part 30 of the closure part 24 is wedged on the drill bit 26, the axially rear part 30 of the closure part 24 is withdrawn with the drill bit 26 in the cavity 16 axially as far as the level of the holding plate 14. There, the circumferential bead 36 snaps into the circumferential groove 44, so that the axially rear part 30 of the closure part 24 is held on the end of the hollow shank 12 having the holding plate 14 (FIG. 5). The drill bit 26 is withdrawn from the rear part 30. The two parts 30, 32 of the closure part 24 close off the cavity 16 in the hollow shank 12 at both ends thereof, trapping an air cushion between them in the cavity 16 of the hollow shank 12, whereby a good insulating effect is achieved. Furthermore, the axially rear part 30 of the closure part 24 prevents plaster applied after the insulating panel fixing plug 10 has been set in position from getting into the cavity 16 of the hollow shank 12.

1. Insulating panel fixing plug, having a hollow shank, which has a holding plate at one end, the holding plate having a through bore through which a cavity of the hollow shank is accessible, characterised in that in the hollow shank (12) there is arranged a closure part (24), which closes off the hollow shank (12) and which transfers driving-in energy for driving the insulating panel fixing plug (10) into a drilled hole (40) from a driving-in tool (26) introduced into the cavity (16) of the hollow shank (12) of the insulating panel fixing plug (10) to the insulating panel fixing plug (10).

2. Insulating panel fixing plug according to claim 1, characterised in that the insulating panel fixing plug (10) comprises a clamping sleeve (18), which protrudes from the hollow shank (12) at the end remote from the holding plate (14).

3. Insulating panel fixing plug according to claim 2, characterised in that the clamping sleeve (18) has a centring tip (20) at its end remote from the holding plate (14).

4. Insulating panel fixing plug according to claim 1, characterised in that the closure part (24) has a location seat (34) for the driving-in tool (26).

5. Insulating panel fixing plug according to claim 4, characterised in that the closure part (24) is wedged with its location seat (34) on the driving-in tool (26), and in that the insulating panel fixing plug (10) has a retaining device (36, 44), which holds the closure part (24) in the hollow shank (12) as the driving-in tool (26) is withdrawn from the hollow shank (12) of the insulating panel fixing plug (10).

6. Insulating panel fixing plug according to claim 4, characterised in that the closure part (24) has a rupturable junction (28), at which the closure part (24) is separated into an axially front and an axially rear part (30, 32) by the driving-in energy applied as the insulating panel fixing plug (10) is driven into a drilled hole.
